(19) United States
(12) Patent Application Publication
(10) Pub. No.: US 2014/0238941 A1
(43) Pub. Date: Aug. 28, 2014

(54) Methods, Devices, and Systems for Creating Highly Adsorptive Precipitates

(71) Applicant: Frederick J. Haydock, Murray, UT (US)

(72) Inventor: Frederick J. Haydock, Murray, UT (US)

(21) Appl. No.: 14/186,398

(22) Filed: Feb. 21, 2014

Related U.S. Application Data
(60) Provisional application No. 61/768,278, filed on Feb. 22, 2013.

(51) Int. Cl. C02F 9/00; C02F 1/52; C02F 1/76; B01D 36/00

(52) U.S. Cl. CPC C02F 9/00; B01D 36/00; C02F 1/52; C02F 1/76
USPC 210/721; 210/335; 210/202; 210/738; 210/726

(57) ABSTRACT

A mixing chamber system for removal of contaminants from a liquid, and related systems and methods, are provided. The mixing chamber system includes a length of pipe having a hollow interior. A plurality of perforated discs are stationarily positioned within the hollow interior in at least a portion of the length of pipe, wherein each of the plurality of perforated discs has a curved profile, wherein a middle portion of each of the plurality of perforated discs is offset from a radial edge of each of the plurality of perforated discs, respectively.

### CROSS REFERENCE TO RELATED APPLICATION

This application claims benefit of U.S. Provisional Application Ser. No. 61/768,278 entitled, “Methods, Devices, And Systems for Creating Highly Adsorptive Precipitates” filed on Feb. 22, 2013, the entire disclosure of which is incorporated herein by reference.

### FIELD OF THE DISCLOSURE

The present disclosure is generally related to liquid treatment methods, devices, and systems and more particularly is related to liquid treatment methods, devices, and systems (such as water treatment methods, devices, and systems) that use mixing chambers for facilitating removal of contaminants by coagulation and precipitation.

### BACKGROUND OF THE DISCLOSURE

Communities and industries today are faced with meeting more stringent regulations for treating and disposing of their wastewater. Recent decisions by the Environmental Protection Agency (EPA) tighten the maximum allowed contamination levels for discharging wastewater containing aluminum, copper, phosphates, and nitrogen-containing bio nutrients to the estuaries, lakes, and inter-coastal waterways, which may result in increased water treatment costs.

There are many commercially available applications and technologies today for removing trace and heavy metals, organic compounds, and bio nutrients such as phosphates, nitrates, nitrites, and ammonia from municipal and industrial water supplies and wastewater streams. Among the available technologies are coagulation and precipitation processes, oxidative medias (such as green sand, granulated ferric hydroxides, etc.), lime softening, dissolved air filtration (“DAF”), biological processes, activated alumina, zeolites, ion exchange resins, cartridge filters, reverse osmosis (“RO”), and membranes.

Some communities (e.g., municipalities) and industries treat or pre-treat process waters and wastewater streams using a single technology with some type of clarification or filtration devices for removing the contaminants and solids formed in the water treatment process. Other communities and industries use a combination of technologies such as coagulation and precipitation for process waters and membrane technologies for removing contaminants to meet locally regulated discharge permits into streams, rivers, ponds, lakes, or inter-coastal waterways. The chemical and operating costs of clarifiers, membranes, and other filtration equipment required to meet federal and state clean water regulations amount to billions of dollars annually worldwide.

Despite the cost, most municipal and industrial water treatment facilities still utilize coagulation and precipitation technologies for removing suspended and dissolved contaminants in the water supply. The chemicals and coagulants used in the precipitation process are selected depending upon the source of the water and the type of contaminants requiring removal. Alum, aluminum chlorides, poly aluminum chlorides, lime, ferric sulfate, ferric chloride, potassium permanganate, potassium hydroxide, and sodium hypochlorite are among the more prevalent chemicals, coagulants, and oxidizers used in the water treatment industry today.

Referring to FIG. 1, a conventional surface water treatment system 100 includes a pumping station 2 that pumps surface water 1 (e.g., water from a lake, stream, or pond) to a preliminary treatment station 3 for removing grit, sand, and some organic matter. The water that has been cleaned of most debris and sand is then pumped to an influent pipe, where it is chlorinated with a pre-chlorination device 4 (e.g., using an injection quill). Pre-chlorination is normally achieved using a 12.5% solution of sodium hypochlorite. In conventional processes, the chlorine is injected into the influent stream and is dispersed through turbulence and friction on the pipe walls. The size of the influent pipe may be based on a flow capacity of components of the water treatment system 100. The pre-chlorinated water is treated with a coagulant 5 prior to entering a flash (i.e., rapid) mixing chamber 6, where the coagulant is further mixed into the water. After flash mixing, the chemically treated water is subjected to additional mixing for several minutes in a flocculation tank 7. The mixed and treated water flows to a sediment basin 8 and is held for several minutes (e.g., between 3 and 17 minutes) to allow a precipitate to form. In the sediment basin 8, an oxidation-reduction reaction takes place, forming (or completing formation of) a precipitate. Precipitate particles, which typically have a diameter of greater than 50 microns, adsorb contaminants. As the sediment basin fills, the water and the precipitates flow into a gravity filter 9, where the solids are separated from the liquid. The gravity filter is a multi-media sand filter, which includes gravel, pre-sized sand, and anthracite. The clean, filtered water exits the gravity filter into a clear well 10 or holding tank. The water from the clear well 10 is chlorinated and/or treated by ultraviolet light 11 to kill bacteria, then is discharged to a holding tank 12. From the holding tank 12, the cleaned water is further pumped 13 to a storage tower 14, and/or to a community distribution system 15. The effectiveness of the surface water treatment system 100 depends, in part, on the effectiveness of the chemical mixers 6 and 7, the amount of time allowed for the coagulation reactions to take place, and the size of the sediment basin 8.

Referring to FIG. 2, a conventional well-water treatment plant 110 removes water from a reservoir using a pumping system 20. The pumping system 20 pumps untreated water under pressure to a sand and grit removal tank 21. Water then flows to a flash mixing chamber 22 where a polymer 23 and a coagulant 24, such as aluminum sulfate, are mixed into the water. In addition, adjustments to the pH of the water can be made in the flash mixing chamber 22. The water is then moved to a baffled section of a flocculation tank 26, which may have a slow-turning mixing device. The effluent leaving the flash mixing chamber 22 is normally chlorinated 25 to accelerate precipitation. Since the process is under the pressure of the well head, the precipitates are separated from the liquid water in multimedia pressure vessels 27. The filtered effluent is chlorinated or treated by ultraviolet radiation 28 and sent to a storage tank 29 and/or a community supply line 30. The effectiveness of the well water treatment system 110 is generally based on the efficiency and the number of the mixing devices 22 and/or 26, the time allowed for the coagulation reaction to take place, and the size of the flocculation tank 26.

Some municipal wastewater treatment plants use digestion processes to break down organic contaminants. In such processes, aluminum sulfates and ploy-aluminum chlorides are injected to remove phosphorus and control other metals. To meet reduced EPA phosphorous level requirements, some communities have added additional aluminum. However, the amount of residual aluminum allowed in wastewater is also under scrutiny and is now posing a problem for the user as well as the manufacturers of aluminum-based coagulants.

The effectiveness of mixing chemical coagulants and oxidants to coagulate and precipitate contaminants in water has been a subject that has been openly debated and discussed in many water treatment forums and publications. Laboratory work performed by state and federal regulatory agencies, engineering firms, and manufacturers of static, cavitation, rapid, or flash mixing devices and systems confirm that mixing and temperature play an important role in the coagulation, oxidation, and precipitation removal of trace and heavy metals in contaminated industrial and municipal drinking water and wastewater streams. However, the type of mixing and the time required to coagulate and precipitate contaminants still remains a contested subject.

Static mixers include a series of geometric mixing elements that have been fixed within a pipe that uses the energy of the liquid or gaseous streams to blend or mix two or more gases and liquids with minimal pressure loss. Some static mixers create high shear forces that damage polymers that are designed to perform a flocculation (i.e., to form precipitates). In water treatment applications, the flocculating ability of the polymer is fragile, and high speeds or heavy shearing will reduce the ability of the polymer to flocculate. In water treatment applications, a controlled amount of mixing can provide improved precipitates and analytical results.

Other mixers include low or high speed motors with shafts and propellers. At high speed operations, propeller type mixers can add unwanted air and foaming to a tank or even create irreversible emulsions. Propeller type mixers are useful in some applications, but overall are not effective in many applications where a complete dispersion of liquid components is required.

One of the most effective known methods of mixing occurs when two or more liquids are gently stirred clockwise and then the stirring motion is changed to counterclockwise. As this is repeated, hot liquids cool faster and liquids blend more effectively as the vortex created by the stirring shifts from a clockwise to a counter clockwise motion. Many static mixing devices are formed in an attempt to duplicate such a stirring action by placing geometric elements in configurations that will roll the liquids together. However, improvements in static mixing devices are desired.

Thus, a heretofore unaddressed need exists in the industry to address the aforementioned deficiencies and inadequacies.

### SUMMARY OF THE DISCLOSURE

Embodiments of the present disclosure provide a mixing chamber system for removal of contaminants from a liquid. Briefly described, in architecture, one embodiment of the system, among others, can be implemented as follows. A length of pipe has a hollow interior. A plurality of perforated discs are stationarily positioned within the hollow interior in at least a portion of the length of pipe, wherein each of the plurality of perforated discs has a curved profile, wherein a middle portion of each of the plurality of perforated discs is offset from a radial edge of each of the plurality of perforated discs, respectively.

The present disclosure can also be viewed as providing a system for removal of contaminants from a liquid. Briefly described, in architecture, one embodiment of the system, among others, can be implemented as follows. A quantity of liquid is carried in an inlet. In a preliminary treatment station, a plurality of organic material is removed from the quantity of liquid. A mixing chamber is in fluid communication with the preliminary treatment station, wherein a quantity of precipitate is separated from the quantity of liquid within the mixing chamber, wherein the mixing chamber comprising: a length of pipe having a hollow interior; and a plurality of perforated discs stationarily positioned within the hollow interior in at least a portion of the length of pipe, wherein each of the plurality of perforated discs has a curved profile, wherein a middle portion of each of the plurality of perforated discs is offset from a radial edge of each of the plurality of perforated discs, respectively. A secondary filter system receives the quantity of water and the quantity of separated precipitate from the mixing chamber, wherein the quantity of separated precipitate is removed from the quantity of water. A chemical treatment system receives the quantity of water from the secondary filter system.

The present disclosure can also be viewed as providing method for removing contaminants from a liquid. In this regard, one embodiment of such a method, among others, can be broadly summarized by the following steps: removing a plurality of organic material from a quantity of liquid within a preliminary treatment station; separating a quantity of precipitate from the quantity of liquid within a mixing chamber in fluid communication with the preliminary treatment station, whereby the quantity of precipitate and the quantity of liquid flow through a plurality of perforated discs stationarily positioned within a hollow interior in at least a portion of a length of pipe, wherein each of the plurality of perforated discs has a curved profile, wherein a middle portion of each of the plurality of perforated discs is offset from a radial edge of each of the plurality of perforated discs, respectively; filtering the quantity of water and the quantity of separated precipitate within a secondary filter system in fluid communication with the mixing chamber, wherein the quantity of separated precipitate is removed from the quantity of water; and chemically treating the quantity of water after the secondary filter system.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic of a conventional water treatment system for treating surface waters.

FIG. 2 is a schematic of a conventional water treatment system for treating well waters.

FIG. 3 is a partial cross-sectional view of a mixing chamber according to an embodiment of the present disclosure.

FIG. 4 is a top view of a curved disc of the mixing chamber of FIG. 3.

FIG. 5 is a side view of the curved disc of FIG. 4, taken from line A-A of FIG. 4.

FIG. 6 is a schematic of a water treatment system suitable for treating surface waters according to an embodiment of the present disclosure.

FIG. 7 is a schematic of a water treatment system suitable for treating well waters according to an embodiment of the present disclosure.

### DETAILED DESCRIPTION

The following description provides specific details in order to provide a thorough description of embodiments of the present disclosure. However, a person of ordinary skill in the art will understand that the embodiments of the present disclosure may be practiced without employing these specific details. Indeed, the embodiments of the present disclosure may be practiced in conjunction with conventional techniques employed in the industry.

In the following detailed description, reference is made to the accompanying drawings, which form a part hereof, and in which are shown, by way of illustration, specific embodiments in which the present disclosure may be practiced. These embodiments are described in sufficient detail to enable a person of ordinary skill in the art to practice the present disclosure. However, other embodiments may be utilized and structural and methodological changes may be made without departing from the scope of the disclosure. The illustrations presented herein are not meant to be actual views of any particular system, device, structure, or method, but are merely idealized representations which are employed to describe the embodiments of the present disclosure. The drawings presented herein are not necessarily drawn to scale. Additionally, elements common between drawings may retain the same or similar numerical designation. However, any similarity in numbering does not mean that the structures or components are necessarily identical in size, composition, configuration, or other property.

As used herein, the term “substantially” in reference to a given parameter means and includes to a degree that one of ordinary skill in the art would understand that the given parameter, property, or condition is met with a small degree of variance, such as within acceptable manufacturing tolerances. By way of example and not limitation, a parameter that is “substantially” met may be at least about 90% met, at least about 95% met, or even at least about 99% met.

As used herein, the phrase “coagulation and precipitation” means and includes any type of oxidation-reduction reaction using oxidizers, coagulants, and/or flocculating agents to treat a contaminated liquid by forming a precipitate including one or more contaminants, to enable the one or more contaminants to be separated from the liquid by clarification and/or filtration.

As used herein, the term “contaminant” refers to any substance suspended or dissolved in an aqueous or non-aqueous liquid that affects the purity of the liquid.

Embodiments of the present disclosure include methods and systems for liquid (e.g., water) treatment that include coagulation and precipitation processes. For example, mixing chambers and components thereof maybe used to produce highly adsorptive particles for increasing an efficiency of coagulation and precipitation processes. The mixing chambers may include a plurality of curved, perforated discs positioned internally along a length of a pipe. In some embodiments, the curvature of adjacent discs may alternate. In some embodiments, the discs may be configured to be fixed relative to the pipe. Thus, the mixing chambers of the present disclosure may not use any external power source (e.g., electricity, hydraulic power). The mixing of liquid passing through the mixing chambers may be enhanced due to turbulence and back-and-forth flow caused by the geometry and configuration of the discs. Accordingly, the coagulation and precipitation process using the mixing chambers of the present disclosure may have increased efficiency compared to conventional systems, and an amount of chemicals used in coagulation and precipitation processes may be reduced to treat similarly contaminated liquid.

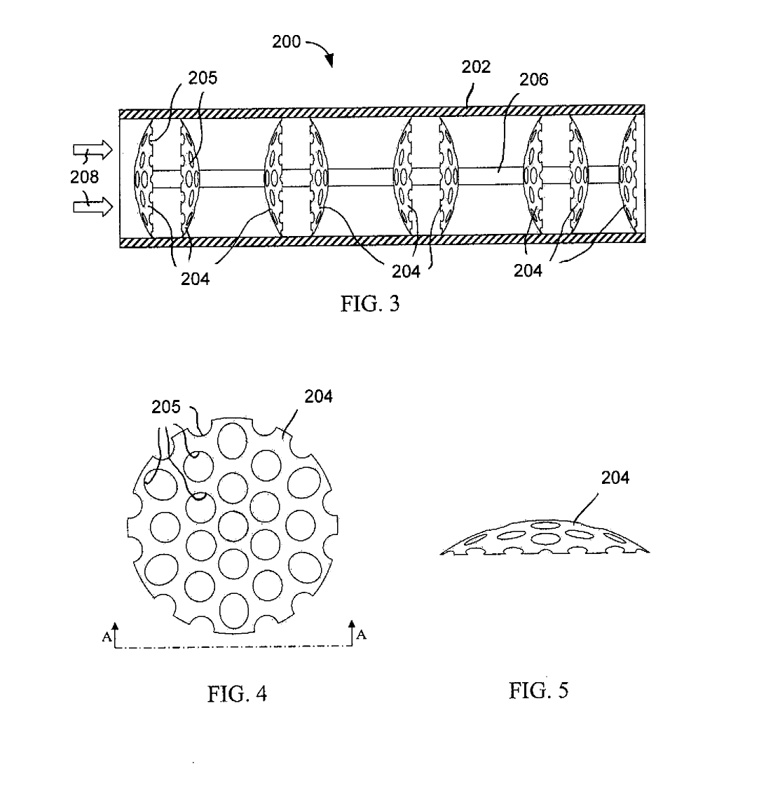

FIGS. 3 through 5 illustrate a mixing chamber 200 and components thereof for a liquid (e.g., water) treatment system. Referring to FIG. 3, the mixing chamber 200 includes a pipe 202 within which a plurality of curved, perforated discs 204 are positioned. As used herein, the term “pipe” means and includes any device or chamber through which a liquid may pass, regardless of the cross-sectional shape or the material composition of the pipe. The discs 204 may include a plurality of cutouts (e.g., perforations) 205 for providing fluid communication through the discs 204. The discs 204 may be coupled to a rod 206 to hold the discs 204 in place relative to each other. Thus, the discs 204 may be spaced along the rod 206 at desired intervals. In some embodiments, the discs 204 may be positioned at constant, regular intervals along the rod 206, as shown in FIG. 3. In other embodiments, the discs 204 may be positioned at variable intervals, such as to accommodate the curved bodies thereof. For example, two adjacent discs 204 that are curved away from each other may be positioned along the rod 206 a first distance from each other, while two adjacent discs 204 that are curved toward each other may be positioned along the rod 206 a second, longer distance from each other.

The discs 204 may be positioned in a fixed location relative to the pipe 202, and may be configured to not rotate or otherwise move relative to the pipe 202. Accordingly, no external power (e.g., electrical or hydraulic power) may be required to operate the mixing chamber 200, other than the power used to flow the liquid through the mixing chamber 200 (which may be provided by gravity, a pump, or a combination thereof, for example). In addition, the mixing chamber 200 may include no moving parts, and may be characterized as a “static” mixing chamber 200. In other embodiments, the discs 204 may be rotated about an axis through which the rod 206 extends and/or moved back and forth along the axis through which the rod 206 extends, if desired for a particular application.

As shown in FIG. 3, the discs 204 may be positioned within the pipe 202 such that the curvature of successive discs 204 alternates. For example, when viewed from an inlet side of the pipe 202, the successive discs 204 may be, respectively, convex, concave, convex, concave, and so forth.

Referring to FIG. 4, each disc 204 may be generally circular or otherwise shaped to correspond to a shape of an interior of the pipe 202. The plurality of cutouts 205 may be positioned at various locations in the disc 204, including along an outer edge of the disc 204 and/or in more central locations. Although the cutouts 205 are shown in FIG. 4, by way of example, as being circular in shape, in other embodiments the cutouts 205 may have any shape, such as triangular, square, rectangular, irregular, ovoid, elliptical, polygonal, etc. In addition, the number and size of the cutouts 205 may be altered to alter flow characteristics, mixing characteristics, pressure loss, etc. of the mixing chamber 200. A central cutout 205 may be used to position the disc 204 on the rod 206.

Referring to FIG. 5, each disc 204 may include a curved body. The curvature of the disc 204 may be approximated by a portion of a sphere. A radius of curvature of the disc 204 may be altered to alter flow and mixing characteristics of the mixing chamber 200. The body of the disc 204 may include any material that is compatible with the liquid and additive(s) to be mixed together using the mixing chamber 200. By way of example and not limitation, the disc 204 may be formed of one or more of a non-corrosive stainless steel, metal, metal alloy, ceramic, and plastic. Depending on the material selected, one of ordinary skill in the art will be capable of forming the discs 204. For example, if the discs 204 are formed of a ceramic or plastic, the discs 204 may be molded, while discs 204 of stainless steel, metal, or metal alloy may be formed by deforming and perforating sheet metal, such as in a metal stamping operation.

During operation, a liquid (such as water) may flow into the inlet of the mixing chamber 200, as shown by arrows 208 in FIG. 3. The liquid may include one or more additives (e.g., a coagulant, a chlorine solution, a polymer, an oxidizer) previously introduced into the liquid, to be further mixed into the liquid using the mixing chamber 204. Alternatively or additionally, one or more additives may be introduced into the liquid within the mixing chamber 204, such as through an inlet extending through a sidewall of the pipe 202 or through a channel and orifice in the rod 206, for example. The shape and configuration of the discs 204 may form turbulent eddies as the liquid passes from a concave disc 204 to a convex disc 204, and/or from a convex disc 204 to a concave disc 204. For example, as the liquid contacts the surface on a convex disc 204, some of the liquid may be forced back toward an adjacent concave disc 204. Thus, at least some of the liquid moves back and forth generally parallel to an axis of the pipe 202. Such back and forth motion has at least two effects. First, a volume of liquid from proximate the convex disc 204 meets a volume of liquid from proximate the concave disc 204. As the two volumes of liquid meet, a vortex is formed similar to a vortex caused by swirling a spoon in a glass of water and then reversing the action of the spoon. The vortex improves the distribution of the additive(s) in the moving liquid matrix and produces a substantially homogeneous mixture. The second effect that is created by the back and forth motion of the liquids is reduced pressure loss due to opposing forces acting on, and canceling out, each other. This is readily observable by monitoring the influent pressure and the effluent pressure in the system. In one experimental embodiment, a pressure loss across more than one hundred feet of piping including discs 204 like those described herein has never been observed to exceed 2 psi.

The mixing chamber 200 of the present disclosure may also enable the formation of precipitates that have a smaller particle size than previously known mixing chambers. Smaller precipitates have a greater surface area per mass of precipitate. The greater surface area may enable adsorption of additional contaminants, and less precipitate may be necessary to remove an equal amount of contamination from a liquid compared to larger precipitates. By way of example, precipitates formed in previously known mixing chambers may have a diameter of about 50 microns or more, while precipitates formed by the mixing chamber 200 of the present disclosure may have an average diameter of less than about 5 microns, in some embodiments. To illustrate the increased surface area of smaller precipitates, the surface area to volume ratio of a sphere (approximating a shape of the precipitates for illustrative purposes) is proportional to the reciprocal of the diameter of the sphere. Thus, if the diameter of a small sphere is ten times smaller than a larger sphere, then the surface area to volume ratio may be about ten times greater than the larger sphere. Thus, the mixing chamber 200 including the curved discs 204 may form precipitates with higher surface area to volume ratios, which may significantly enhance surface adsorbing capacities of precipitates of a given mass.

In some embodiments, oxygen may be introduced into the liquid at an inlet side of the mixing chamber 200 to facilitate the breakdown of organic materials into carbon dioxide and water. The discs 204 may enhance oxidation of contaminants, such as organic material. Air or oxygen bubbles may be efficiently mixed and dissolved into the liquid matrix at a relatively higher ratio of dissolved oxygen in the liquid compared to prior known mixers. The increased oxygen ratio may make more oxygen available for further oxidation, which may reduce biochemical oxygen demand (BOD) and chemical oxygen demand (COD) requirements for breaking down organic contaminants.

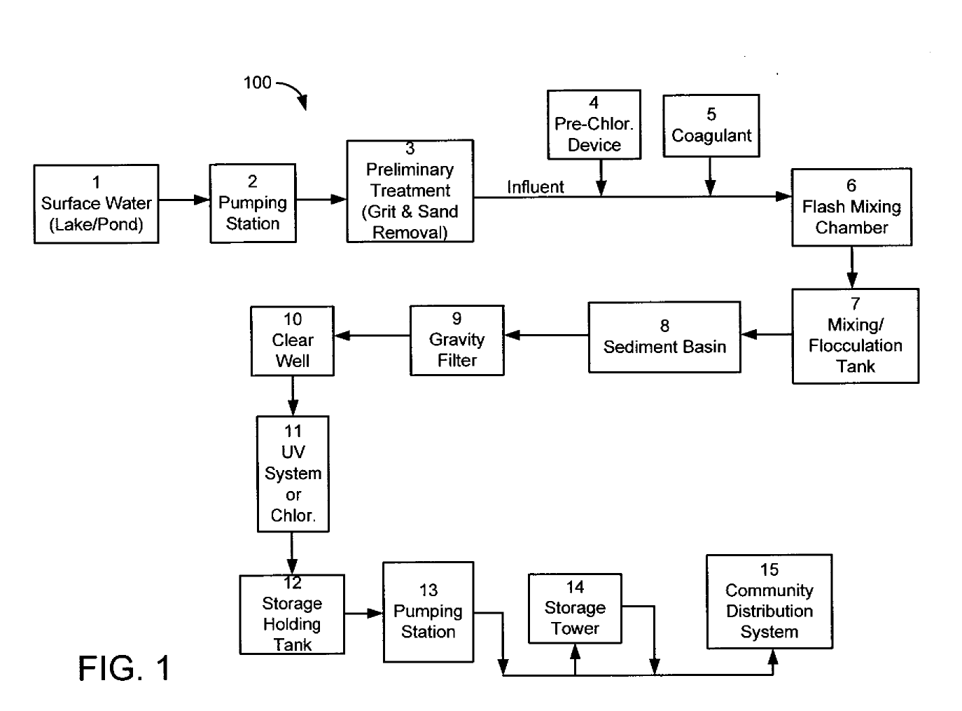

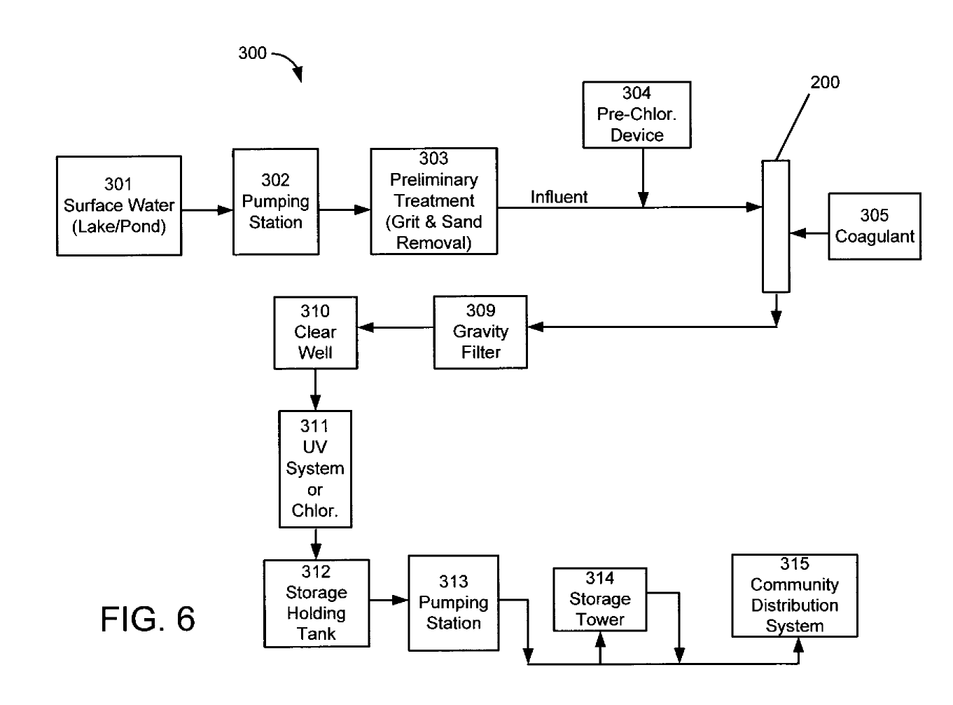

FIG. 6 illustrates a surface water treatment system 300 similar to the surface water treatment system 100 of FIG. 1, except that the flash mixing chamber 6, mixing/flocculation tank 7, and sediment basin 8 may be removed and replaced by the mixing chamber 200 of the present disclosure. In addition, in some embodiments, a coagulant 305 may be introduced into the water within the mixing chamber 200, rather than prior to the water entering the mixing chamber 6, as described above. Furthermore, the amount of additives (e.g., oxidizer, coagulant) injected into the water being treated may be less than in the system 100 described above, due to the improved mixing of the water and additives in the mixing chamber 200 and the enhanced precipitate formation.

In the surface water treatment system 300 of FIG. 6, surface water 301 may be pumped 302 to a preliminary treatment 303 for removing sand, grit, and other materials (e.g., organic materials), as described above. The pre-chlorination device 304 may be used to inject an oxidizer into the water prior to the water entering the mixing chamber 200. The mixing chamber 200 may enhance the mixing of the chlorine oxidizer, and may be an injection point for the coagulant 305. As described above, the mixing chamber 200 may effectively mix the oxidizer and coagulant 305 into the water. In some embodiments, the coagulant 305 may be or include ferric chloride.

As described above, water leaving the mixing chamber 200 may enter a gravity filter 309 to remove precipitates. The gravity filter 309 may include sand, such as red garnet sand, to filter out the precipitates. Then, the water may enter a clear well 310. The water may be further treated by ultraviolet light and/or chlorination 311. A storage holding tank 312 may hold the water until it is pumped 313 to a storage tower 314 and/or a community distribution system 315, as described above.

As the flash mixing chamber 6, the flocculation tank 7, and the sediment basin 8 are replaced with the mixing chamber 200, which may be physically smaller than the flash mixing chamber 6, the flocculation tank 7, and the sediment basin 8, the surface water treatment system 300 may have a smaller footprint than the conventional system. In addition, capital expenditures and maintenance costs for specialized tanks, electric motors, and mixing paddles/propellers may be reduced, such as by more than 50%.

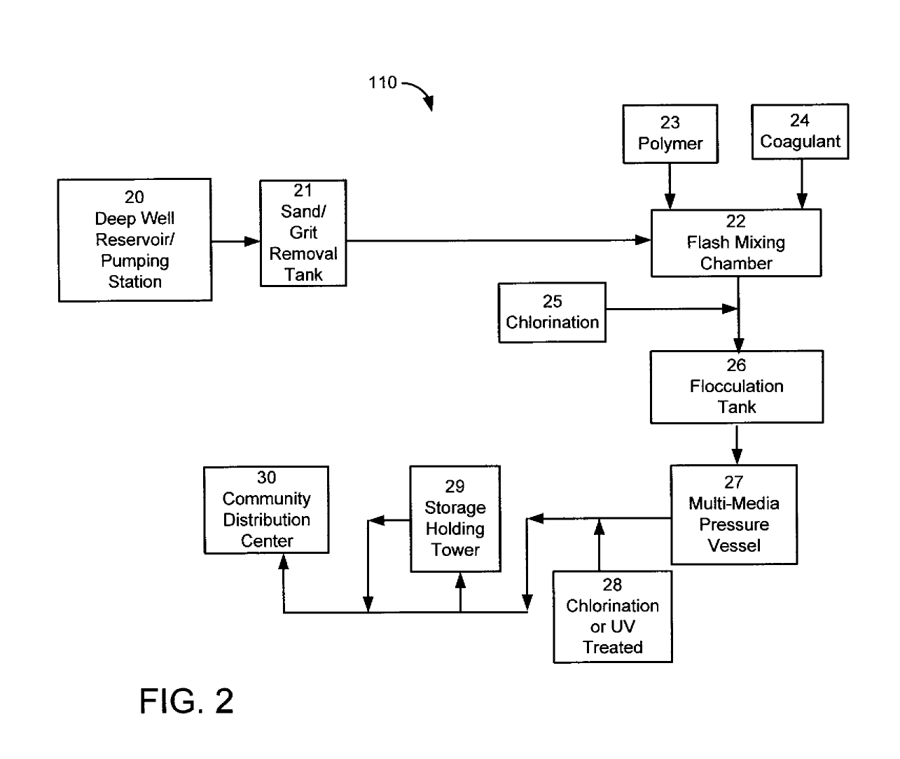

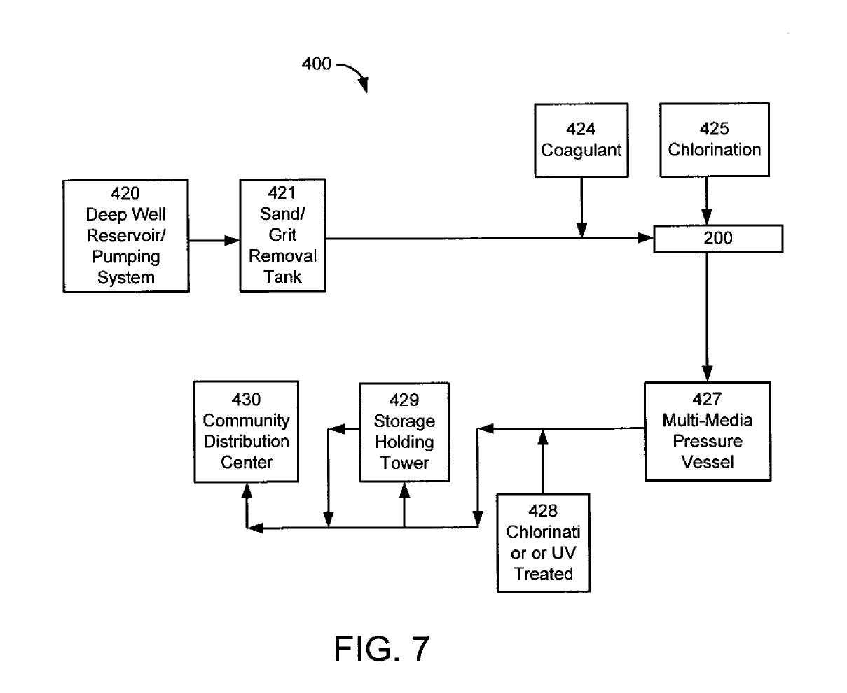

FIG. 7 illustrates a well water treatment system 400 similar to the well water treatment system 110 of FIG. 2, except that the flash mixing chamber 22, the polymer injection system 23, and the flocculation tank 26 may be replaced by the mixing chamber 200 of the present disclosure. In addition, in some embodiments, the chlorination device 25 may be replaced with a chlorination device 425 that injects a chlorine oxidizer directly into the mixing chamber 200. Furthermore, the mixing chamber 200 may have a smaller physical footprint than the flash mixing chamber 23, the flocculation tank 22, and the polymer injection system 24, which may provide cost savings. Additionally, costs may be reduced by using no polymer, additional mixers, flocculation tanks, or sediment basins.

In the well water treatment system 400 of FIG. 7, well water 420 may be pumped to a sand/grit removal tank 421, as described above. The coagulant 424 may be injected into the water prior to the water reaching the mixing chamber 200. The chlorination device 425 may inject a chlorine oxidizer into the mixing chamber 200. The water and additives may be mixed in the mixing chamber 200, as described above. After leaving the mixing chamber 200, the water may pass through a multi-media pressure vessel 427, as described above The water may be chlorinated and/or treated under ultraviolet light 428 prior to entering a storage holding tower 429 and/or a community distribution center 430, as described above.

Thus, the present disclosure includes methods of creating highly adsorptive precipitates including (a) admixing contaminated wastewater with an effective amount of ferric chloride as a coagulating agent and an effective amount of an oxidizing agent to raise the oxidation state of metals and contaminants and accelerate the formation of a precipitate; (b) introducing said mixture under pressure into a reaction/mixing vessel containing a stainless steel or other non-corrosive material configured such that the flow path of the mixture is continuously, kinetically mixed without losing a significant amount of head pressure, thus assuring that all contaminants in the mixture have been contacted by the chemical coagulating and precipitating agents; (c) subjecting the mixture inside the kinetic flow path of the reaction vessels so that the forming precipitate is under shear, dividing the contaminant laden and non-laden precipitate into millions of smaller particles with massive surface areas that effectively adsorb more contaminants; and (d) separating the flocculated precipitates from the water phase with sand filtration. The reaction/mixing vessel may include curved, perforated discs through which the mixture flows, and the curved, perforated discs may have alternating curvatures.

Although the mixing chambers, systems, and methods of the present disclosure have been generally described in the context of water treatment, the disclosure is not limited to water treatment applications. For example, the mixing chamber 200 and systems 300 and 400 may be used for treating any liquid, whether aqueous or non-aqueous. By way of another example, the mixing chamber 200 may be used in mixing processes other than coagulation and precipitation processes, such as in processes for mixing any two liquids, a solute into a solvent, or particles into a liquid. Additional uses for the mixing chambers, systems, and/or methods of the present disclosure will be apparent to one of ordinary skill in the art upon consideration of the present disclosure. Such additional uses and applications are also included in the present disclosure.

The present invention incorporates the benefits of controlled mixing in aqueous or non-aqueous solutions by gently moving two or more liquids in forward and reverse motions (i.e., in eddies formed when liquids pass through the configuration of the mixing chamber 200 and its components) so that the turbulent motions blend, stir, and mix the liquids into a substantially homogeneous mixture, whether large or small volumes of liquid are treated. The motion of the liquids also provides a sustained kinetic energy, which may accelerate the reaction time of contaminated liquids to form a precipitate within the mixing chamber, so that sediment or settling tanks are eliminated.

The methods, systems, and devices of the present disclosure may be used to admix coagulants, oxidizers, polymers, and pH adjusting chemicals with contaminated aqueous or non-aqueous solutions requiring low contamination levels (after treatment), as mandated by regulatory agencies, without the assistance of utility power.

The methods, systems, and devices of the present disclosure may also be used to admix large or small volumes of water at low or high pressures with various water treatment chemicals at reduced dosage rates, which may create a highly adsorptive precipitate that can be separated in a multimedia filter without the use of a sediment basin.

Without being bound by theory, the methods, systems, and devices of the present disclosure may also incorporate the motion of the liquids and their transfer path to create a shear force on the precipitates formed in the oxidation-reduction action. Such a shear force may be sufficient to create millions of small particles with highly adsorptive surface areas. These particles may instantly flocculate within or upon leaving the mixing chamber, which may facilitate the separation of the contaminants from the liquid.

A particular embodiment of the device can create nano sized particles (e.g., <0.2 microns) under low to high pressures. These particles can recombine to form precipitates greater than 50 microns (50,000 nm), improving separation of the solids from water by conventional means. Another embodiment relates to a system for blending and mixing coagulants, polymers and oxidizing agents into contaminated water for improved separation, coagulation and separation of the solids from the water phase. Embodiments of the device for improve the oxidation of water from an outside source of air through cavitation of the movement of water in the flow path. By changing the configuration of the concave/convex discs, and the angle of flow in the discs, cavitation and temperature can be increased, thus increasing the kinetic energy of the process of coagulation and the breakdown of organic compounds.

Particular embodiments of the device improve the removal of phosphorus in wastewater systems to less than 30 ppb. Other embodiments of the device are designed for blending chemicals in non-aqueous solutions.

Particular embodiments of the device can improve the removal of colloidal suspensions in aqueous and non-aqueous solutions. Other devices and methods are designed to improve the removal of total suspended solids by precipitation in aqueous solutions. Some embodiments of the method and device can remove up to 26 metals in a single process. Certain embodiments of the method and device may work in pH ranges from 4.0 to 9.5 without the use of pH adjusting chemicals.

Alternative embodiments of the system and method are designed for eliminating settling tanks and basins, reducing capital expenditures. An alternative system can be designed to eliminate rapid mix, flash and other static mixing devices. The systems and methods can be designed to generate superior removal of contaminants

The embodiments of the disclosure described above and illustrated in the accompanying drawing figures do not limit the scope of the invention, since these embodiments are merely examples of embodiments of the disclosure. The invention is defined by the appended claims and their legal equivalents. Any equivalent embodiments lie within the scope of this disclosure. Indeed, various modifications of the present disclosure, in addition to those shown and described herein, such as alternative useful combinations of the elements described, will become apparent to those of ordinary skill in the art from the description. Such modifications and embodiments also fall within the scope of the appended claims and their legal equivalents.

What is claimed is:

1. A mixing chamber system for removal of contaminants from a liquid, the mixing chamber system comprising:
a length of pipe having a hollow interior; and
a plurality of perforated discs stationarily positioned within the hollow interior in at least a portion of the length of pipe, wherein each of the plurality of perforated discs has a curved profile, wherein a middle portion of each of the plurality of perforated discs is offset from a radial edge of each of the plurality of perforated discs, respectively, wherein at least a first of the plurality of perforated discs is positioned in opposition to at least a second of the plurality of perforated discs and the first perforated disc and the second perforated disc are orientated differently.

2. The mixing chamber system of claim 1, further comprising a rod connected to at least a portion of the plurality of perforated discs.

3. The mixing chamber system of claim 1, wherein the plurality of perforated discs are positioned at spaced intervals along a length of the rod.

4. The mixing chamber system of claim 1, wherein the first perforated disc and the second perforated disc are reflectively orientated to each other.

5. The mixing chamber system of claim 4, wherein the radial edges of the first and second perforated discs is positioned closer together than the middle portions of the first and second perforated discs.

6. The mixing chamber system of claim 1, wherein a distance between an interior curvature of a first and a second perforated discs of the plurality of perforated disks is less than a distance between an exterior curvature of the second and a third perforated discs of the plurality of perforated discs.

7. The mixing chamber system of claim 1, wherein the radial edge of each of the plurality of perforated discs contacts an inner wall of the length of pipe.

8. A system for removal of contaminants from a liquid, the system comprising:
an inlet carrying a quantity of liquid;
a preliminary treatment station, wherein a plurality of organic material is removed from the quantity of liquid;
a mixing chamber in fluid communication with the preliminary treatment station, wherein a quantity of precipitate is separated from the quantity of liquid within the mixing chamber, wherein the mixing chamber comprising:
a length of pipe having a hollow interior; and
a plurality of perforated discs stationarily positioned within the hollow interior in at least a portion of the length of pipe, wherein each of the plurality of perforated discs has a curved profile, wherein a middle portion of each of the plurality of perforated discs is offset from a radial edge of each of the plurality of perforated discs, respectively, wherein at least a first of the plurality of perforated discs is positioned in opposition to at least a second of the plurality of perforated discs and the first perforated disc and the second perforated disc are orientated differently;
a secondary filter system receiving the quantity of water and the quantity of separated precipitate from the mixing chamber, wherein the quantity of separated precipitate is removed from the quantity of water; and
a chemical treatment system receiving the quantity of water from the secondary filter system.

9. The system of claim 8, further comprising a coagulant mixed into the quantity of water.

10. The system of claim 9, wherein the coagulant is mixed into the quantity of water before the quantity of water enters the mixing chamber.

11. The system of claim 9, wherein the coagulant is mixed into the quantity of water within the mixing chamber.

12. The system of claim 9, wherein the coagulant further comprises ferric chloride.

13. The system of claim 8, further comprising a chlorination device, wherein the chlorination device injects a quantity of chlorine oxidizer into the mixing chamber.

14. The system of claim 9, wherein the secondary filter system removes the coagulant and separated precipitate from the quantity of water.

15. A method for removing contaminants from a liquid, the method comprising the steps of:
removing a plurality of organic material from a quantity of liquid within a preliminary treatment station;
separating a quantity of precipitate from the quantity of liquid within a mixing chamber in fluid communication with the preliminary treatment station, whereby the quantity of precipitate and the quantity of liquid flow through a plurality of perforated discs stationarily positioned within a hollow interior in at least a portion of a length of pipe, wherein each of the plurality of perforated discs has a curved profile, wherein a middle portion of each of the plurality of perforated discs is offset from a radial edge of each of the plurality of perforated discs, respectively, wherein at least a first of the plurality of perforated discs is positioned in opposition to at least a second of the plurality of perforated discs and the first perforated disc and the second perforated disc are orientated differently;
filtering the quantity of water and the quantity of separated precipitate within a secondary filter system in fluid communication with the mixing chamber, wherein the quantity of separated precipitate is removed from the quantity of water; and
chemically treating the quantity of water after the secondary filter system.

16. The method of claim 15, further comprising the step of mixing a coagulant into the quantity of water.

17. The method of claim 16, wherein the coagulant is mixed into the quantity of water before the quantity of water enters the mixing chamber.

18. The method of claim 16, wherein the coagulant is mixed into the quantity of water while the quantity of water is within the mixing chamber.

19. The method of claim 15, further comprising the step of mixing in a quantity of chlorine into the quantity of water while the quantity of water is within the mixing chamber.

20. The method of claim 15, wherein the secondary filter system removes the coagulant and separated precipitate from the quantity of water.
